(19) United States
(12) Patent Application Publication
(10) Pub. No.: US 2008/0212165 A1
(43) Pub. Date: Sep. 4, 2008

(54) Bistable Display Devices

(75) Inventors: Henri Jagt, Eindhoven (NL); Guofu Zhou, Eindhoven (NL); Peter Jan Slikkerveer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,214

(22) PCT Filed: Jun. 12, 2006
(86) PCT No.: PCT/IB2006/051865

§ 371 Date: Dec. 12, 2007

(30) Foreign Application Priority Data
Jun. 17, 2005 (EP) 05105393.2

(51) Int. Cl. G02F 1/167; G02F 1/00; G09G 3/34

(52) U.S. Cl. 359/296; 359/237; 345/107

(57) ABSTRACT

A bistable display device comprises a first substrate (22) carrying, on one side, a plurality of electrode segments (28, 30) and supply lines (26) connecting to the segments. The electrode segments comprise a first set of electrode segments (30) which define the display regions for providing information to the user, and a second set of electrode segments (28) which defines a background display region. Each supply line (26) is sandwiched laterally between electrode segments such that the visual display output in the region of the supply line is substantially the same as that in the region of the electrode segments which sandwich the supply line. The electrode segments which sandwich the supply lines dominate the electric field distribution in the display medium layer so that visibility of the supply lines is reduced, even though they are formed on the same substrate surface as the electrode segments.

This invention relates to display devices, in particular segmented bistable display devices.

Electrophoretic display devices are one example of bistable display technology, which use the movement of particles within an electric field to provide a selective light scattering or absorption function.

In one example, white particles are suspended in an absorptive liquid, and the electric field can be used to bring the particles to the surface of the device. In this position, they may perform a light scattering function, so that the display appears white. Movement away from the top surface enables the colour of the liquid to be seen, for example black. In another example, there may be two types of particle, for example black negatively charged particles and white positively charged particles, suspended in a transparent fluid. There are a number of different possible configurations.

It has been recognized that electrophoretic display devices enable low power consumption as a result of their bistability (an image is retained with no voltage applied), and they can enable thin display devices to be formed as there is no need for a backlight or polarizer. They may also be made from plastics materials, and there is also the possibility of low cost reel-to reel processing in the manufacture of such displays.

For example, the incorporation of an electrophoretic display device into a smart card has been proposed, taking advantage of the thin and intrinsically flexible nature of a plastic substrate, as well the low power consumption.

The most simple configuration of display device is a segmented reflective display, and there are a number of applications where this type of display is sufficient. A segmented reflective electrophoretic display has low power consumption, good brightness and is also bistable in operation, and therefore able to display information even when the display is turned off.

In a typical top-bottom electrode structure, the electrophoretic display is controlled by means of a lower electrode layer and an upper electrode layer, between which the display medium is sandwiched. Biasing voltages are applied selectively to electrodes in the upper and/or lower electrode layers to control the state of the portion(s) of the display medium associated with the electrodes being biased.

In a segmented display configuration, the segmented electrodes are provided on one of the substrates and are each driven independently with the desired voltage to give the desired optical state (a so-called direct drive scheme). A common electrode can be provided on the opposing substrate.

This invention relates in particular to the manufacture of the substrate carrying the segmented electrodes. This substrate is typically made by laminating an electrophoretic foil onto a backplane, structured with the display area electrode segments. The backplane may be a flexible foil or other type of substrate, for example a thin PCB, plastic film or glass.

If the supply line leads for the segmented electrodes are on the same side of the substrate as the segmented electrodes, they cause modulation of the display layer in the same way as the segmented electrodes, and are therefore visible. One way to overcome this problem is to provided a double-sided backplane foil, in which supply line leads for the segments are provided on the rear side of the foil and connected to the segmented electrodes on the opposite front side using vias. The processing of a two-sided foil in this way is laborious, has a lower yield and is therefore expensive.

There is therefore a need for a low cost process for providing a segmented electrode pattern on a single side of a substrate and which enables the visual appearance of supply line leads to be reduced.

According to the invention, there is provided a display device, comprising:

a first substrate carrying, on one side, a plurality of electrode segments and supply lines connecting to the segments, wherein the electrode segments comprise a first set of electrode segments which defines display regions for providing information to the user, and a second set of electrode segments which defines a background display region;

a second substrate carrying a second electrode arrangement; and

a bistable display medium layer between the first and second substrates,

wherein each supply line is sandwiched between electrode segments such that the visual appearance of the display medium layer in the region of the supply line is substantially the same as the visual appearance of the display medium layer in the region of the electrode segments which sandwich the supply line.

In this arrangement, electrode segments are arranged to sandwich the supply lines, in such a way that they dominate the electric field distribution in the display medium layer. As a result, the supply lines can have a voltage applied to them for controlling the selected display segments to be driven to a particular state, but the driving of the display medium layer to the same state is avoided (or substantially reduced) in the vicinity of the supply lines, or corrected to the colour of the background upon subsequent addressing of the background. This reduces or eliminates the visibility of the supply lines, even though they are formed on the same substrate surface as the electrode segments. A single sided electrode pattern can thus be used for the display without seeing the supply lines connected to the driven electrode segments. The avoidance of driving of the display medium layer to the same state in the vicinity of the supply lines is the result of induced cross talk from the electrode segments, with the display medium optical state in the vicinity of the supply lines primarily dependent on the signals applied to the electrode segments which sandwich the supply line.

The supply lines and the electrode segments (preferably segments of the background electrode) form an interdigitated pattern, with the background electrode segments significantly wider than the supply lines.

The width of each supply line is preferably less than 5% of the width of each of the surrounding electrode segments, and more preferably less than 2% or even 1%.

The spacing between the two electrode segments between which the supply line is sandwiched is preferably less than 10% of the width of the two electrode segments, and more preferably less than 5%, 2%, or even 1%.

The spacing between the two electrode segments between which the supply line is sandwiched is preferably less than 10% of the spacing between the substrates, and the width of each supply line is also preferably less than 10% of the spacing between the substrates.

These measures enable the electric field in the vicinity of the supply lines to be dominated by the adjacent electrode segments. For example, the supply lines may for example have a width of 3-6 μm, the space on each side of each supply line may also be in the range 3-6 μm, and the spacing between the substrates may be 30-100 μm.

The electrode segments (the combination of the background pattern and the electrode segment pattern) preferably fill substantially all of the display area, so that all of the supply lines can be sandwiched as described above.

The electrophoretic display medium layer may comprise particles of a first colour (for example black or white) suspended in a medium of a second colour (for example white or black), or the medium may be transparent. There may also be two types of particle.

The invention also provides a method of operating a bistable display device, the display device comprising a first substrate carrying, on one side, a first set of electrode segments which defines display regions for providing information to the user and supply lines connecting to the segments, and a second set of electrode segments which defines a background display region, and a second substrate carrying a second electrode arrangement, wherein the method comprises:

applying a first relative voltage between a group of the first set of electrode segments within a portion of the display and the second electrode arrangement, and a second relative voltage between the second set of electrode segments and the second electrode arrangement, the group being selected in dependence on the image to be displayed, thereby to drive the display device in the vicinity of the group of electrodes to a desired optical state for displaying the image,

wherein the method further comprises supplying voltages to the electrodes of the group using supply lines each of which is sandwiched between electrode segments of the second set.

In this method, a display image is formed by providing different drive conditions for the electrodes of the image to be displayed and all other electrodes. The supply lines to the display regions are flanked by electrodes which carry the opposite drive condition voltage, and these suppress the modulation of the display layer by the supply lines.

The drive method is preferably applied to the full display (the portion being the full display), but the portion may instead be only a part of the display.

The method may further comprise, before applying the first and second relative voltages, performing an initialization phase using the first and second sets of electrode segments to drive at least the portion of the display to be controlled to a first optical state. This initially drives all electrodes to one state.

The initialization phase may comprise applying an initialization relative voltage between the electrode segments of the first and second sets and the common electrode. This resets the display portion to one colour. More complicated intialization phases may be used, and this will depend on the drive requirements of the particular display technology.

This initialization relative voltage can be obtained by applying a first voltage on the common electrode and a second voltage on the first and second sets of electrodes, the first relative voltage can be obtained by applying the second voltage to the common electrode and the group of electrode segments, and the second relative voltage can be obtained by applying the second voltage to the common electrode and the first voltage to the second set of electrode segments. In this way, the three different drive configurations can be defined by two voltages only, for example positive and negative voltages of equal magnitude.

In one version of the method, the initialization phase involves driving the display to the foreground colour. Thus, the first optical state comprises the desired optical state. The second relative voltage is the selected to switch the display from the desired optical state to the background colour (the opposite optical state), and this switches all electrode segments other than the selected group to the background colour.

Instead of using two voltage levels only, the common electrode voltage can be fixed at a common voltage, and the first and second relative voltages are obtained by applying first and second voltages, with the common voltage between the first and second voltages. This scheme thus uses three voltage levels.

This is of particular benefit to implement a drive scheme in which the initialization phase involves driving the display to the background colour. In this case, the first optical state is an opposite optical state to the desired optical state.

Examples of the invention will now be described in detail with reference to the accompanying drawings, in which:

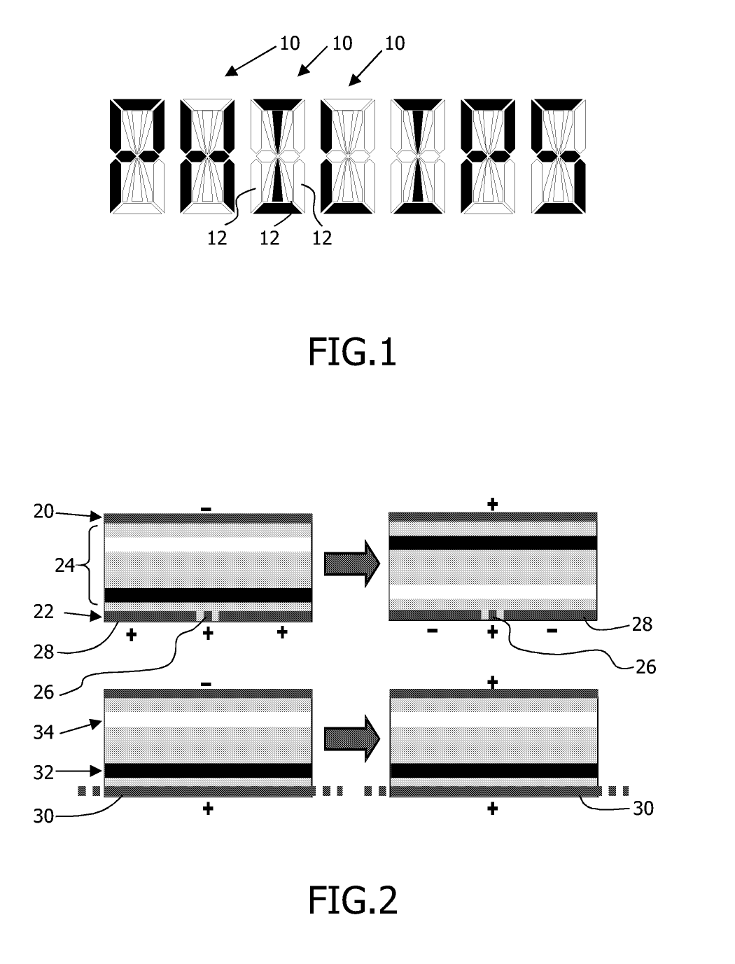

FIG. 1 shows the type of display to which the invention can be applied;

FIG. 2 shows a first example of display configuration and drive scheme of the invention;

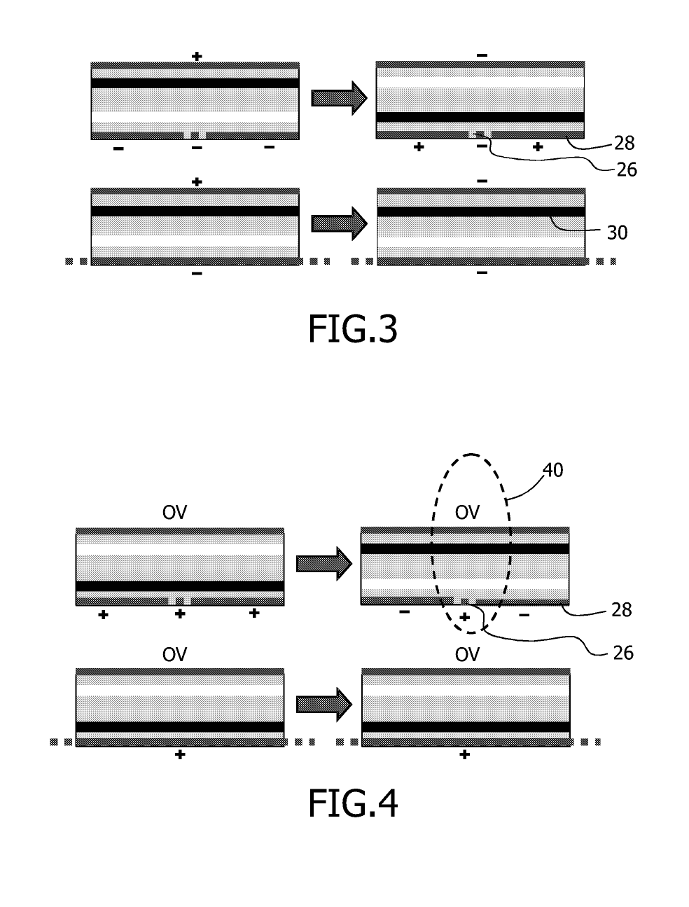

FIG. 3 shows a second example of drive scheme of the invention;

FIG. 4 shows a third example of drive scheme of the invention;

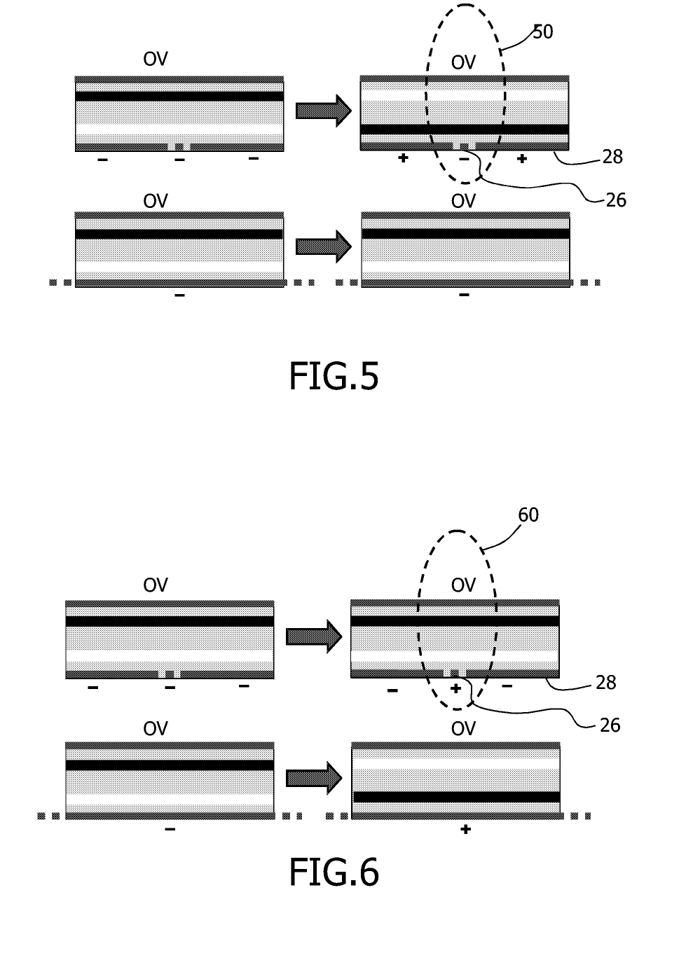

FIG. 5 shows a fourth example of drive scheme of the invention;

FIG. 6 shows a fifth example of drive scheme of the invention;

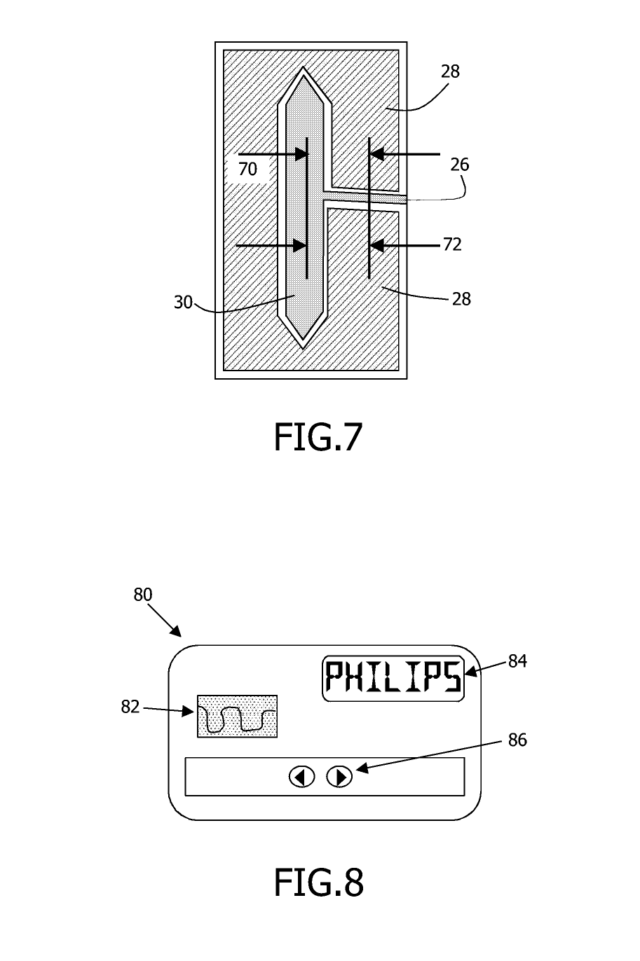

FIG. 7 shows in plan view a simplified segmented electrode layout to further clarify the display configuration of the invention; and

FIG. 8 shows a smart card using a display of the invention.

The same references are used in different Figures to denote the same layers or components, and description is not repeated.

This invention relates to bistable display devices. Bistability in a display device can enable low power operation, and a display output even when the device is off. Electrophoretic display devices are one example of bistable display technology, and the invention will be described using one example of electrophoretic display design.

This type of display can use the movement of particles in a number of ways. The invention relates in particular to a system generating transverse electric fields. In this configuration, particles are controlled to move selectively up and down the display material layer. When the particles are at the top, they are visible, and when they are at the bottom, then they are not visible, and the medium supporting the particles is then visible (or else other particles which have been moved to the top surface are then visible). A black and white display or a colour display can be implemented in this way. For example, the particles may be white, and the supporting medium may be red, green or blue for a colour implementation.

This invention is particularly concerned with low cost and simple displays, and for this reason the example of the invention given below uses a simple display configuration, of a direct driven two-colour (e.g. black and white) segmented display. The invention may however be applied to other segmented display designs.

FIG. 1 shows the type of display to which the invention can be applied, and shows a 7 digit segmented display, with each digit 10 having electrodes 12 in a star configuration. Each electrode segment 12 (of which there are 14 for each digit) has an associated supply line, enabling independent control of each electrode. These supply lines are not shown in FIG. 1. The area around the segmented electrodes of the seven digits is also arranged as one large background electrode, and this is used to drive those parts of the bistable display into a defined state. The background electrode may be arranged as one pattern, but it may instead be arranged as multiple segments, electrically connected together.

FIG. 2 shows the segmented electrode backplane, and the electrophoretic foil is laminated on top of this in several layers:
a glue layer to adhere to the segmented electrode backplane foil;
the electrophoretic layer;
a common electrode layer formed from ITO; and
a plastic foil as support for the common electrode layer.

FIG. 2 is used to explain a first implementation of the invention. The invention relates both to the structure of the segmented electrodes and the drive scheme used to address the electrodes.

The segmented electrodes and the supply lines connecting to the electrode segments are provided on the same side of the substrate. In FIG. 2, the common electrode layer is shown as 20 and the segmented electrode layer is shown as 22, with the electrophoretic display layer 24 sandwiched between.

The segmented electrode layer 22 has supply lines 26, a background electrode arrangement 28 and electrode segments 30 which are for providing information to the user. These segments 30 are the 14 segments of each digit in FIG. 1.

The supply lines 26 are sandwiched laterally between electrode segments 28, in particular electrode segments of the background electrode. The control of the display layer 24 is based on the transverse electric field, and the proximity of the electrodes 28 to the supply line 26 causes the electric field pattern associated with the electrodes 28 to interact with the electric field pattern of the supply line, such that the control of the display medium layer in the region of the supply line is dependent on the signals applied to the electrode segments 28 which sandwich the supply line.

The supply lines 26 have a small width, so that the influence of the electrodes 28 becomes dominant. In particular, the width of the supply lines 26 and spacing between the supply lines and adjacent electrodes is kept small in comparison to the distance to the common electrode, namely in comparison to the display layer thickness.

For example, the supply lines should have a width which is less than ⅓ of the display layer thickness, and preferably as small as ⅕ or even 1/10 of the spacing. This spacing is typically approximately 50 μm, and the width of the supply lines 26 can be approximately 5 μm.

The lateral spacing on each side of the supply line 26 should also be kept as small as possible, to enable the electric field associated with the background electrode 28 to influence the display layer in the vicinity of the supply line 26. In particular, the distance on each side of the supply line is less than 3 times the width of the supply line, and preferably approximately equal to the supply line width (5 μm in this example). This separation and the supply line width must be scaled down if there is a decreased segment size. Thus, the dimension of the space between the segments between which the supply line is sandwiched may be selected in dependence on the background electrode segment sizes and the patterned electrode segment sizes, as well as the display layer thickness.

The electrode segments (the combination of the display segments 30 and the background electrode 28) fill substantially all of the display area, so that within the display area, the supply lines can all be arranged to be surrounded by other electrode portions.

As mentioned above, the electrode layout design and the supply line width enables the influence of the supply lines on the display layer to be reduced, and the way this can improve the display quality will now be explained.

In one preferred implementation of drive scheme, a two stage process is employed. FIG. 2 shows the first stage of the process on the left and the second stage on the right. The top part of FIG. 2 shows a region of the segmented electrode substrate where there is a supply line 26 sandwiched between background electrode portions 28, and the bottom part of FIG. 2 shows a region of the segmented electrode substrate where there is an electrode 30 to be driven as part of the display output.

The drive scheme of the invention will be explained in connection with a black and white display, in which black particles are attracted to a positive voltage and white particles are attracted to a negative voltage. In fact, only one set of particles needs to be moved in other display configurations.

The example of FIG. 2 is for a display to be viewed from the side of the display of the common electrode 20. A black band 32 shows where the black particles collect and a white band 34 shows where the white particles collect.

FIG. 2 shows the operation for the display of a black background with white (i.e. reflective) image portions being used to provide information to the user. FIG. 2 shows schematically the use of two possible drive voltages, + and −.

The first step of the process (the left column in FIG. 2) involves driving all the electrodes to the positive voltage, and driving the common electrode to the negative voltage. This has the effect of driving the full display to white.

In the second phase, the background electrode 28 and all segments that are not part of the image to be displayed are driven to the opposite voltage, namely to the negative voltage. Also, the polarity of the common electrode is switched.

The segments 30 are not changed in their optical state, because the polarity has not been reversed, and the display is bistable. Instead, the polarity has changed to neutral. These segment electrodes are large, for example with width of approximately 0.5 mm, and they retain their original optical state, despite the change in polarity of the nearby background electrode portions.

The background electrode (as well as the segments which do not form part of the image to be displayed) has changed polarity, and the output of the display in these background regions changes to black, as shown in the top right part of FIG. 2.

The supply lines 26 are very thin (3 to 20 μm) compared to the thickness of the electrophoretic medium (and adhesive) between the common electrode and backplane electrodes. Due to crosstalk, the electric field of the surroundings thus has a strong influence on the electrophoretic medium at the supply line, which makes the display in the vicinity of the supply line optically switch in the same way as the surroundings. Thus, even though the supply line voltage is not inducing a switching operation, switching of the optical layer takes place. The supply line voltage is the same as the common electrode voltage, and this condition is described as “neutral” in the following description. The supply lines of the segments thus remain indistinguishable from the surroundings.

FIGS. 3 to 6 show the same parts of the display and show the two phases, in the same way as FIG. 2, and also show the same type of display design (with black and white particles attracted to opposite voltages).

FIG. 3 shows the same operation principle for displaying black text (or other information) on a white background.

In the first phase, on the left of FIG. 3, the display is driven to black, and in the second phase, the electrode segments for the image to be displayed are reversed in polarity and thereby driven to white. Again, the supply line 26 is not controlled to generate a change in optical state, as it is driven to neutral, but the electric field influence from the neighbouring background electrode enables switching to take place.

In the two examples above, the first phase involves driving the full display to the state required for the selected image segments. Selected electrodes are then turned off. This results in a flash of the output display state.

However, the alternative approach, to drive the full display to the off state, and then switch the desired electrode segments to the on state, does not enable suppression of the display modulation caused by the supply lines 26. In particular, the supply lines 26 are then attempting to drive the display layer to change the optical state. The background electrodes would be at the same potential as the common electrode, and there is thus no electric field acting to resist this change in optical state in the vicinity of the supply lines.

A display using three switching levels can be used to implement the same functionality described above, but also can implement switching from an off to an on state from the first to the second phase of the drive scheme.

FIG. 4 shows the control of a display in which the common electrode is driven to 0 Volts, and the segemented electrodes are driven to a positive or negative voltage, and FIG. 4 implements the same drive scheme as FIG. 2.

The electrodes on the segmented electrode substrate 22 are controlled in exactly the same way as for the embodiment of FIG. 2, but the common electrode remains at 0V. In this case, the interfering electric field of the background electrode has to overcome an opposite bias at the region of the supply lines (as outlined at 40), rather than overcoming the neutral bias in FIG. 2. For this reason, the supply line widths and spacings are more critical.

FIG. 5 also shows the control of a display in which the common electrode is driven to 0 Volts, and implements the same drive scheme as FIG. 3.

Again, the electrodes on the segmented electrode substrate 22 are controlled in exactly the same way as for the embodiment of FIG. 3, but the common electrode remains at 0V. The interfering electric field again has to overcome an opposite bias at the region of the supply lines (as outlined at 50), rather than overcoming the neutral bias in FIG. 3.

However, the use of three (or more) control voltages can enable the first phase to comprise the off state, and the transition to the second phase can then involve switching the optical state of the desired segments.

FIG. 6 shows the use of the three level drive scheme to implement a first phase which is black, and a second phase which switches the desired electrodes to white. Region 60 shows that the supply line 26 is attempting to switch the state of the optical layer. In this case, there is an opposing electric field from the background electrodes. To increase the influence of the electric field associated with the background electrode, the magnitude of the negative polarity voltage can be made greater than the magnitude of the positive polarity voltage.

Of course, a display of black on a white background can also be implemented using the same principles as explained with reference to FIG. 6.

As explained above, the invention enables the supply lines to be switched to a different optical state than the connected electrode segments, when the surrounding background electrode segments are supplied with correct voltage, due to the induced cross talk. However, the switching speed of the area around the supply lines will be lower than the switching speed of the surrounding areas, as there is a lower effective voltage.

It has been observed that the visual change in the optical state of the display is obtained only when the particles are moved a certain distance. When a relatively low driving voltage is used, the particles may not move a sufficient distance for the change in optical state to take effect within the time available. This can be used to improve the switching speed in the vicinity of the supply lines.

For example, with reference to FIG. 5, the optical state in the vicinity 50 of the supply line is being switched, but the negative voltage on the supply line will slow the switching speed in this area, even though the positive electric field of the surrounding electrodes is dominant.

To increase the switching speed in the vicinity of the supply line, it is possible to supply a bias voltage on the supply line of the same polarity as the voltage supplied to the surrounding electrode (e.g. +2 V on the supply line 26 for the example of FIG. 5 with a higher voltage for the electrodes 28, e.g. +10V). This bias this will add to the field induced by the surrounding electrodes and increase the switching speed.

This bias voltage will of course also be applied to the selected electrode segment, and this means the selected electrode segment has a polarity which tends to switch the display portion associated with the selected electrode segments. This optical switching is not desired, and thus, the bias voltage level is chosen to be sufficiently low that visual optical switching does not take place in the addressing time.

With reference to the example of FIG. 5, this results in an intialization phase, using 0V and −10V for example (the left column of FIG. 5) and a drive phase using 0V, 10V and 2V (the + and the − in the right column of FIG. 5 being changed to 10V and 2V).

The same approach can be used to modify the other drive schemes where there is switching of the display in the vicinity of the supply lines (FIGS. 2 to 4).

A further approach for increasing switching time (and to remove the dependency of the display output on the previous display output history) is to use a series of shaking pulses (ac pulses). These can be applied to the background electrodes around the supply line, prior to supplying the DC driving voltage. These shaking pulses can significantly increase the switching speed as the particles located above the supply line become more mobile upon the application of these ac fields.

A single shaking pulse may be used or a series of short duration shaking pulses, and these can use the same voltage levels as required for the other phases of the drive scheme. A duration is selected to release particles in one of the extreme positions, but without driving the particles to the opposite extreme position. The effect of the shaking pulse or pulses is to increase the mobility of the particles such that the subsequent drive condition can have an immediate effect on the location of the particles. Multiple shaking pulses can successively use the opposite polarity voltage levels.

By way of example, shaking pulses may have a duration of the order of ones or tens of milliseconds, for example six 20 ms pulses of alternating voltage, giving an additional drive phase, between the intialization phase and the final drive phase, of 120 ms duration.

The use of shaking pulses in electrophoretic displays has been described, for example, in WO 03/079323 and WO 03/100757, in particular in connection with active matrix display configurations. These and other publications of the applicant provide further explanation and examples of shaking pulse arrangements which can be used in the segmented display configuration of the invention.

The switching response of the display layer can also, of course, be varied by selecting appropriate voltage levels.

For completeness, FIG. 7 shows the electrode arrangement of the invention in plan view, and for simplicity shows a single electrode segment 30 with its supply line 26, and the background electrode 28. Reference 70 shows how the cross section which forms the bottom images in FIGS. 3 to 6, and reference 72 shows how the cross section which forms the top images in FIGS. 3 to 6.

Electrophoretic display systems can form the basis of a variety of applications where information may be displayed, for example in the form of information signs, public transport signs, advertising posters, pricing labels, billboards etc. In addition, they may be used where a changing non-information surface is required, such as wallpaper with a changing pattern or colour, especially if the surface requires a paper like appearance.

One example of the use of the display of the invention is integrated into a smart card, as shown in FIG. 8. FIG. 8 shows a smart card 80 with a conventional smart card memory device 82 and a display 84 of the invention. The smart card also has user input controls 86 as shown.

As mentioned above, the invention has been explained with reference to one type of display configuration and one type of display layer. The invention can be applied to numerous other display layer arrangements, including bistable LCD displays.

As mentioned above, the method may be applied to only a portion of the display. For example, in a power saving or standby mode, only a portion of the display may be addressed, for example indicating only essential information when the device is in standby mode (such as battery strength).

The preferred operating method described uses an initialization phase for all electrodes, but this may not be required depending on the display type and other steps of the drive scheme.

Various modifications will be apparent to those skilled in the art.

1. A display device, comprising:
a first substrate (22) carrying, on one side, a plurality of electrode segments (28,30) and supply lines (26) connecting to the segments, wherein the electrode segments comprise a first set of electrode segments (30) which defines display regions for providing information to the user, each electrode segment having an associated supply line (26), and a second set of electrode segments (28) which defines a background display region forming an area around the electrode segments;
a second substrate (20) carrying a second electrode arrangement; and
a bistable display medium layer (24) between the first and second substrates,
wherein each supply line (26) is sandwiched between electrode segments such that the visual appearance of the display medium layer in the region of the supply line (26) is substantially the same as the visual appearance of the display medium layer in the region of the electrode segments (28) which sandwich the supply line.

2. A device as claimed in claim 1, wherein the second electrode arrangement comprises a common electrode.

3. A device as claimed in claim 1, wherein the bistable display medium layer (24) comprises an electrophoretic display medium layer.

4. A device as claimed in claim 1, wherein the electrode segments which sandwich the supply line are electrode segments of the second set (28), and the supply lines (26) are connected to electrode segments of the first set (30).

5. A device as claimed in claim 1, wherein the first and second sets of electrode segments (28,30) fill substantially all of the display area.

6. A device as claimed in claim 1, wherein the width of the supply line (26) is less than 5% of the width of the surrounding electrode segments (28).

7. A device as claimed in claim 1, wherein the spacing between the two electrode segments (28) between which the supply line is sandwiched is less than 10% of the width of the two electrode segments (28).

8. A device as claimed in claim 1, wherein the spacing between the two electrode segments between which the supply line (26) is sandwiched is less than 10% of the spacing between the substrates (20,22).

9. A device as claimed in claim 1, wherein the combined width of a supply line (26) and the spacing on each side of the supply line is 3-20 μm.

10. A smart card (80) comprising a memory device (82) and a display device (84) as claimed in claim 1.

11. A method of operating a bistable display device, the display device comprising a first substrate (22) carrying, on one side, a first set of electrode segments (30) which defines display regions for providing information to the user and supply lines (26) connecting to the segments, each electrodes segment having an associated supply line (26), and a second set of electrode segments (28) which defines a background display region forming an area around the electrode segments, and a second substrate (20) carrying a second electrode arrangement, wherein the method comprises:
applying a first relative voltage between a group of the first set of electrode segments (30) within a portion of the display and the second electrode arrangement, and a second relative voltage between the second set of electrode segments (28) and the second electrode arrangement, the group being selected in dependence on the image to be displayed, thereby to drive the display device in the vicinity of the group of electrodes to a desired optical state for displaying the image,
wherein the method further comprises supplying voltages to the electrodes of the group using supply lines (26) each of which is sandwiched between electrode segments of the second set.

12. A method as claimed in claim 11, wherein the portion comprises the full display.

13. A method as claimed in claim 11, wherein the method further comprises, before applying the first and second relative voltages, performing an initialization phase using the first and second sets of electrode segments to drive at least the portion of the display to a first optical state.

14. A method as claimed in claim 13, wherein the initialization phase comprises applying an initialization relative voltage between the electrode segments of the first and second sets (28,30) and the second electrode arrangement.

15. A method as claimed in claim 14, wherein the initialization relative voltage is obtained by applying a first voltage (+; −) on the second electrode arrangement and a second voltage (−;+) on the first and second sets of electrodes, the first relative voltage is obtained by applying the second voltage (−;+) to the second electrode arrangement and the group of electrode segments, and the second relative voltage is obtained by applying the second voltage (−;+) to the second electrode arrangement and the first voltage (+;−) to the second set of electrode segments.

16. A method as claimed in claim 11, wherein the first optical state comprises the desired optical state, and the second relative voltage is selected to switch the display from the desired optical state to an opposite optical state.

17. A method as claimed in claim 11, wherein the second electrode arrangement is fixed at a common voltage, and the first and second relative voltages are obtained by applying first and second voltages, with the common voltage between the first and second voltages.

18. A method as claimed in claim 16, wherein the first and second relative voltages have the same polarity but different magnitude.

19. A method as claimed in claim 18, wherein the magnitude of the first relative voltage is not sufficient to cause switching of the optical state.

20. A method as claimed in claim 18, wherein the second electrode arrangement voltage is fixed at a common voltage, and the first and second relative voltages are obtained by applying first and second voltages, with the second electrode arrangement voltage greater than or less than each of the first and second voltages.

21. A method as claimed in claim 11, wherein the first optical state is an opposite optical state to the desired optical state.

22. A method as claimed in claim 21, wherein the second electrode arrangement voltage is fixed at a common voltage, and the first and second relative voltages are obtained by applying first and second voltages, with the common voltage between the first and second voltages.

23. A method as claimed in claim 11, further comprising applying ac pulses to the first set of electrode segments and/or the second set of electrode segments before applying the first and second relative voltages.

24. A method as claimed in claim 11, wherein the display state in the region of the supply lines is the same as that in the region of the electrode segments of the second set which sandwich the supply lines as a result of induced cross talk from the electrode segments of the second set.
